(19) United States
(12) Patent Application Publication
(10) Pub. No.: US 2025/0379529 A1
(43) Pub. Date: Dec. 11, 2025

(54) X-SHAPED ULTRASONIC MOTOR AND ROBOTIC ARM

(71) Applicant: Seagate Technology LLC, Fremont, CA (US)

(72) Inventors: Yichao MA, Singapore (SG); Xiong LIU, Singapore (SG); Barish CHAKRAVARTY, Singapore (SG)

(21) Appl. No.: 19/234,019

(22) Filed: Jun. 10, 2025

Related U.S. Application Data
(60) Provisional application No. 63/658,341, filed on Jun. 10, 2024.

(51) Int. Cl. H02N 2/12; B25J 9/12; H02N 2/14

(52) U.S. Cl. CPC H02N 2/123; B25J 9/126; H02N 2/14

(57) ABSTRACT

The apparatus disclosed herein includes a single X-shaped ultrasonic motor (X-USM) and robotic arm with a ball joint, with is an actuator that can generate high torque and precise positioning for three degree of freedom (3-DOF). In one implementation, the X-shaped USM disclosed herein includes a plurality of electrodes configured such that a bottom surface of each of the electrodes is attached to a bottom surface of another of the electrodes and a side surface of each of the electrodes is attached to a side surface of another of the electrodes, wherein each of the electrodes having notch in vicinity of a notch of the other electrodes such that the notches form an opening at the center of the motor device and wherein each of the electrodes are configured to be excited by electric signal

### CROSS REFERENCE TO RELATED APPLICATIONS

This application is a non-provisional application based on and claims benefit of priority to U.S. provisional patent application No. 63/658,341 filed on Jun. 10, 2024, and entitled X-SHAPED ULTRASONIC MOTOR AND ROBOTIC ARM, which is incorporated herein by reference in its entireties.

### BACKGROUND

A robotic arm is a type of mechanical arm, usually programmable, with similar functions to a human arm. Robotic arms with a ball joint can perform complex and precise movements in small areas, such as industrial automation, 3-D printing, medical procedures, etc. For example, articulated robots use a ball joint to connect the control arms to the steering knuckles and delta robots use a ball joint to attach the arms to a central end effector. Active ball joint mechanism is a novel design that uses a ball joint to move an output link with three degrees of freedom. However, the design of such robotic arm is very complex due to more than one actuator are used.

### SUMMARY

The apparatus disclosed herein includes a single X-shaped ultrasonic motor (X-USM) and robotic arm with a ball joint, with is an actuator that can generate high torque and precise positioning for three degrees of freedom (3-DOF). In one implementation, the X-shaped USM disclosed herein includes a plurality of electrodes configured such that a bottom surface of each of the electrodes is attached to a bottom surface of another of the electrodes and a side surface of each of the electrodes is attached to a side surface of another of the electrodes, wherein each of the electrodes having notch in vicinity of a notch of the other electrodes such that the notches form an opening at the center of the motor device and wherein each of the electrodes are configured to be excited by electric signal.

This Summary is provided to introduce a selection of concepts in a simplified form that are further described below in the Detailed Description. This Summary is not intended to identify key features or essential features of the claimed subject matter, nor is it intended to limit the scope of the claimed subject matter. These and various other features and advantages will be apparent from a reading of the following Detailed Description.

### BRIEF DESCRIPTIONS OF THE DRAWINGS

FIG. 1 illustrates an example block diagram of an ultrasonic motor (USM) that can provide one-axis force.

FIG. 2 illustrates an example block diagram of a cross ultrasonic motor (X-USM) that can provide force along multiple axis.

FIG. 3 illustrates examples of FEM simulation results of creating 3-degree of freedom (DOF) motion of using the X-USM.

FIG. 4 illustrates components of an example design using ball-to-socket joint (or ball joint) together with specialized designed X-USM for a 3-DOF robotic arm to simulate the human shoulder joint movement.

FIG. 5 illustrates an example block diagram of an X-USM tip in contact with a ball joint.

### DETAILED DESCRIPTION

A robotic arm is a type of mechanical arm, usually programmable, with similar functions to a human arm. Robotic arms with a ball joint can perform complex and precise movements in small areas, such as industrial automation, 3-D printing, medical procedures, etc. For example, articulated robots use a ball joint to connect the control arms to the steering knuckles and delta robots use a ball joint to attach the arms to a central end effector. Active ball joint mechanism is a novel design that uses a ball joint to move an output link with three degrees of freedom. However, the design of such robotic arm is very complex due to more than one actuator being used.

The technology disclosed herein includes a single X-shaped ultrasonic motor (X-USM) and robotic arm with a ball joint, which is an actuator that can generate high torque and precise positioning for three degrees of freedoms (3-DOF).

In one implementation, the X-shaped USM disclosed herein includes a plurality of electrodes configured such that a bottom surface of each of the electrodes is attached to a bottom surface of another of the electrodes and a side surface of each of the electrodes is attached to a side surface of another of the electrodes, wherein each of the electrodes having notch in vicinity of a notch of the other electrodes such that the notches form an opening at the center of the motor device and wherein each of the electrodes are configured to be excited by electric signal.

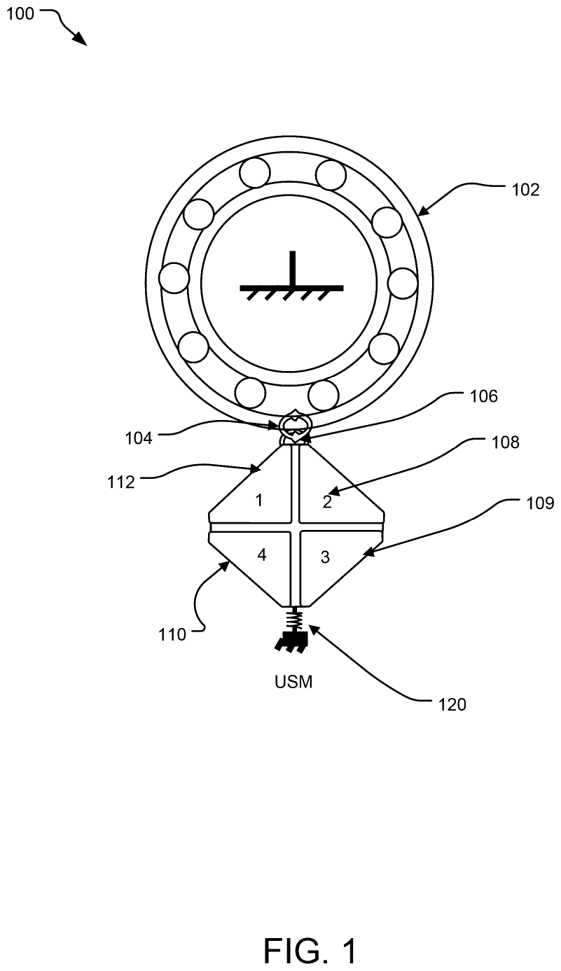

Specifically, the current USMs can only provide only one axis force as shown in FIG. 1. For example, the USM 100 may include a rotor 102 that allows a USM tip 106 that may have elliptic motion as illustrated by 104. The USM 100 includes piezoelectric (PZT) electrodes 1-4 108-112 that allows force along an axis when exciting all the electrodes. Furthermore, it can provide force along a 45 degree line when exciting both the electrodes in X-Z plane and the electrodes in Y-Z plane with the same voltage and a force along other angle lines, when exciting both the electrodes in X-Z plane and the electrodes in Y-Z plane with the different voltages. As a result, the current solution requires more than one actuator to provide the 3-D motion such as human arm or shoulder rotator.

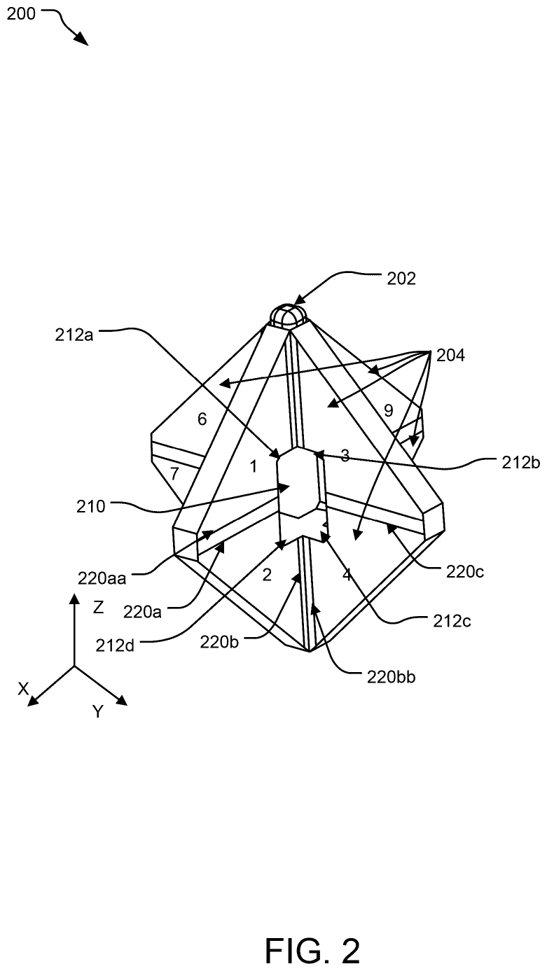

FIG. 2 illustrates a block diagram of a X-Shaped cross ultrasonic motor (X-USM) 200 that can provide force along multiple axis. Specifically, FIG. 2 illustrates X-USM motor 200 including sixteen (16) electrodes 204. In the illustrated implementation, each of the 16 electrodes are of triangular form with each triangular form having electrodes on two opposite surfaces. Thus, the X-USM 200 may be configured with eight (8) electrode pieces. While in the illustrated implementation, the electrodes 204 are configured in triangular form, in alternative implementations, the electrodes 204 may have an alternative form, such as square, triangle with one side being an arc, etc. Furthermore, while the electrodes 204 are illustrated to be symmetric in dimensions along X, Y and Z axis in that the lengths of the sides 220 of the triangles attached to each other are substantially similar, in alternative implementation, the dimensions 220 may be asymmetric in that 220a maybe different than 220b and 220c, etc.

Furthermore, each of the electrodes 204 are configured such that a bottom surface 220a of each of the electrodes is attached to a bottom surface 220aa of another of an electrode 204. Similarly, a side surface 220a of each of the electrodes is attached to a side surface 220aa of another of the electrodes 204. Furthermore, each of the electrodes 204 has a notch 212 that are in vicinity of each other and together the notches 212 form an opening 210 at the center of the X-USM 200.

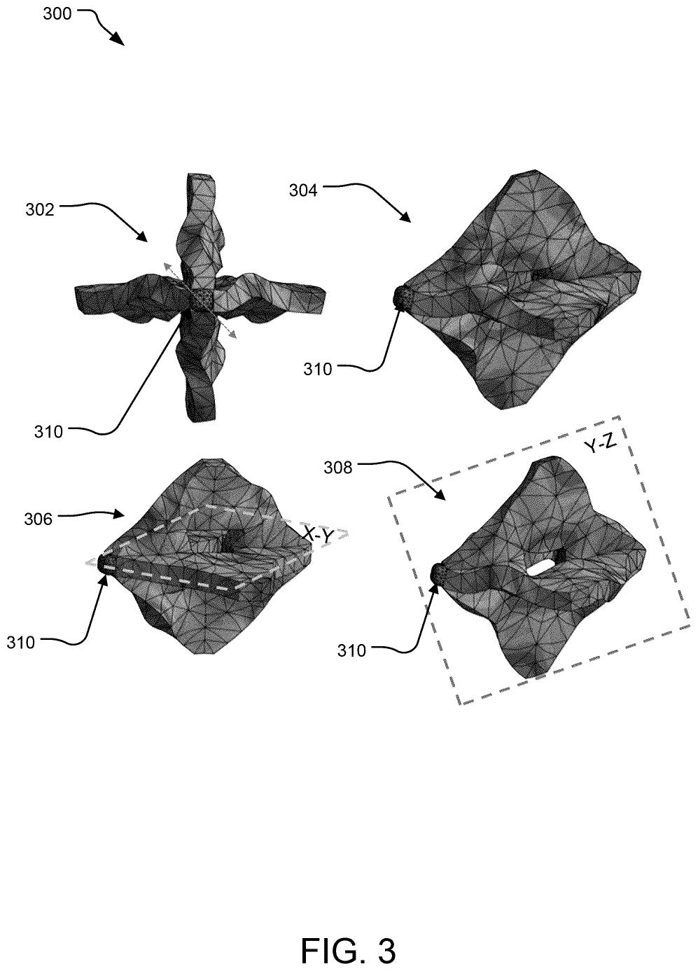

The electrodes 204 are configured so as to provide an opening 210 at the center of the X-USM 200. The configuration of the opening 210 allows the X-USM 200 to generate motion in 3-D that can be transferred via a USM tip 202 to other mechanisms such as a robotic arm. Each of the electrodes 204 may be made of PZT material. Specifically, when the electrodes are excited by applying voltage thereto, they cause 3-D motion of the X-USM 200 in the manner further disclosed in FIG. 3.

In the illustrated implementation the USM tip 202 is attached to the top near top edges of eight of the 16 electrodes 204. However, in an alternative implementation, the USM tip 202 may be attached to the bottom near bottom edges of eight of the 16 electrodes 204. Alternatively, the USM tip 202 may be configured in other locations such as near four side edges of the 16 electrodes 204.

Specifically, FIG. 3 illustrates examples of FEM simulation results of creating 2-degree of freedom (DOF) motion of using the X-USM. Each of the illustrations 302-308 illustrates force generated by the X-USM when different excitations are given to each of the 16 electrodes (or 8 pairs of electrodes) disclosed in FIG. 2. For instance, the FEM simulations 302 (front view) and 304 (side view) demonstrate motion along a 45-degree axis of the X-SUM when identical excitation is applied to each of the eight electrode pairs. However, if there is an imbalance in the excitation between the vertical and horizontal sides, the motion axis shifts accordingly, resulting in movement along a different angle. In principle, the motion axis can span the full 360 degrees. Two extreme cases illustrate this behavior: (1) When the four electrode pairs on the Y-Z plane receive zero excitation, the USM tip (310) moves within the X-Y plane, as shown in simulation 306. (2) Conversely, when the four electrode pairs on the X-Y plane receive zero excitation, the USM tip (310) moves within the Y-Z plane, as depicted in simulation 308.

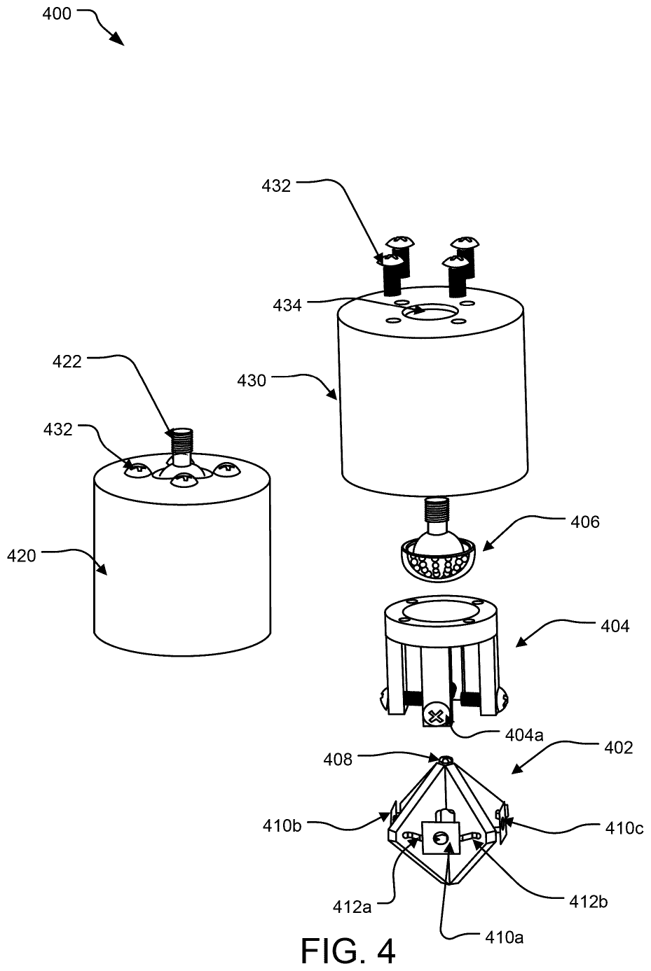

As shown in FIG. 4, the X-USM operates in conjunction with a ball joint. When the USM tip (408) contacts the ball joint (406) at its base, it enables the end effector (422) of the ball joint to rotate across multiple planes, achieving 3-DOF motion. When this end effector (422) is integrated with industrial equipment—such as a robotic arm—the 3-DOF motion generated by the X-USM ball joint assembly can be effectively transferred to the mechanism, enabling precise and flexible movement.

FIG. 4 illustrates components of an example application 400 of the X-USM 402 disclosed herein for an industrial application using ball-to-socket joint (or ball joint) together with specialized designed X-USM 402 for a 3-DOF robotic arm to simulate the human shoulder joint movement. Specifically, making use of the ball-to-socket joint (or ball joint) together with specialized designed X-USM 402 for a 3-DOF robotic arm allows to simulate the human shoulder joint movement. As shown in FIG. 4, pre-load springs (4×) 412 are used to suspend the X-USM 402 and one housing is used to secure the contacts between a ball joint 406 and X-USM tip 408. This ensures the driving mechanism to perform the 3-DOF movement. The M3 screw thread allows for the arm piece attachment.

Specifically, the X-USM 402 includes connector plates 410 that are attached to the electrodes of the X-USM 402 using pre-load spring mechanisms 412. Specifically, each of the four connector plates 410 may be connected to two pairs of electrodes on each side. The connector plates 410 may be mounted inside a ball-bearing housing 404 using screws 404a. Furthermore, a ball-joint 406 may be housed in the ball-bearing housing 404. The ball-joint 406 may be attached to a robotic arm, an actuator, or other application using a cylinder 420 having a screw-thread 422. Specifically, the cylinder 420 may be configured to be located inside a top cover 430 and attached to the top cover 430 using screws 432. Specifically, the cylinder 420 may be configured to be located inside a top cover 430 such that the screw-thread 422 protrudes from an opening 434 of the top cover 430. In the illustrated implementation, the electrodes of the X-USM 402 do not have any direct contact with the ball-bearing housing 404. Attaching the X-USM 402 using the pre-load springs (4×) 412 allows the tip 408 to move the ball-bearing 406 without any movement of the ball-bearing housing 404.

The preload springs 412 play an important part in ensuring consistent and efficient operation. Specifically, they apply a constant force that X-USM against the ball joint. This contact with pre-load is useful for transferring ultrasonic vibrations into mechanical motion via friction. Furthermore, such proper preload ensures optimal frictional contact, which maximizes energy transfer and minimizes slippage or energy loss.

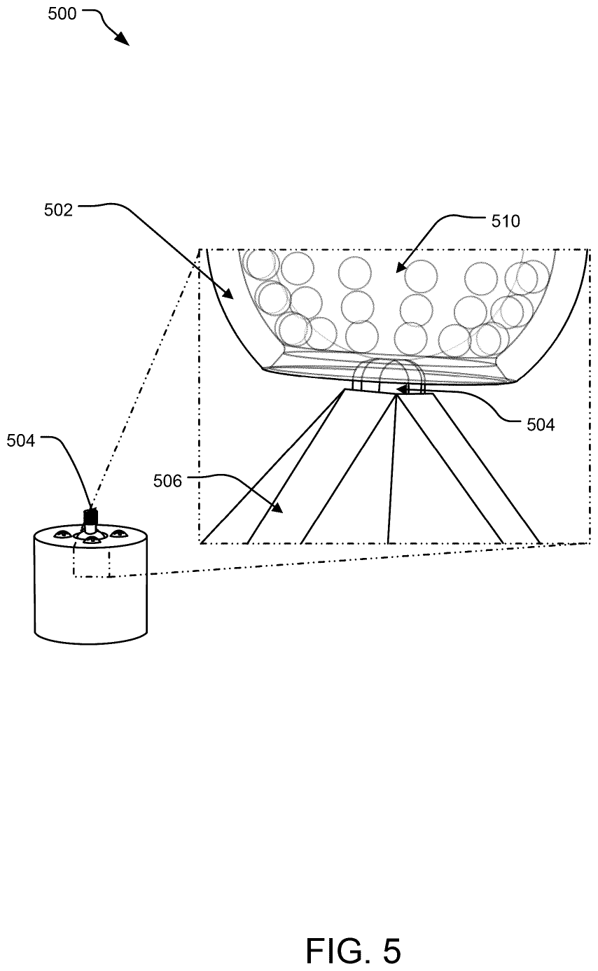

FIG. 5 illustrates an example block diagram of an X-USM tip 504 in contact with a ball joint 502 having a number of balls 510. As shown in FIG. 5, the X-USM tip 504 is configured on electrodes 506. With the configuration of the X-USM tip 504 with the ball joint 502, the X-USM may provide the 3-DOF motion to any mechanism attached to the end tip of the ball joint.

The technology disclosed herein provides a number of technical advantages, including the following.

Precision Control: The X-type USM's precision in movement allows for intricate operations that require meticulous manipulation, making it ideal for tasks that demand high accuracy.

Compact Design: The integration of the USM with a spherical bearing contributes to a more compact and efficient design, reducing the overall footprint of the robotic arm assembly.

Enhanced Flexibility: With three DOF, the robotic arm can maneuver in ways that mimic the human arm, including movements such as pitching, yawing, and rolling.

The X-USM may be used in a number of applications including in manufacturing, where automated processes can be made more efficient, or in the medical field, where delicate surgeries could be performed with greater precision.

The above specification, examples, and data provide a complete description of the structure and use of exemplary embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A motor device, comprising:
a plurality of electrodes configured such that a bottom surface of each of the electrodes is attached to a bottom surface of another of the electrodes and a side surface of each of the electrodes is attached to a side surface of another of the electrodes; and
each of the electrodes having notch in vicinity of a notch of the other electrodes such that the notches form an opening at the center of the motor device,
wherein each of the electrodes is configured to be excited by electric signal.

2. The motor device of claim 1, wherein each of the electrodes is a piezoelectric (PZT) electrode.

3. The motor device of claim 1, further comprising a motor-tip attached near top edges of the plurality of electrodes.

4. The motor device of claim 1, wherein the electrodes are attached to a connector plate via pre-load springs.

5. The motor device of claim 4, further comprising a ball-bearing housing configured to be attached to the motor device using the connector plates.

6. The motor device of claim 5, wherein the ball-bearing housing further configured to attach to a ball-joint.

7. The motor device of 6. wherein the USM-tip is configured to be attached to a bottom of the ball-joint.

8. The motor device of claim 7. wherein the ball-joint configured to attach the motor-tip to at least one of a robotic arm and an actuator.

9. A device, comprising:
a plurality of electrodes configured in X-shape such that a bottom surface of each of the electrodes is attached to a bottom surface of another of the electrodes and a side surface of each of the electrodes is attached to a side surface of another of the electrodes; and
each of the electrodes having notch in vicinity of a notch of the other electrodes such that the notches form an opening at the center of the motor device.

10. The device of claim 9, wherein each of the electrodes is a PZT electrode configured to be excited by electric signal.

11. The device of claim 10, further comprising a motor-tip attached near top edges of the plurality of electrodes.

12. The device of claim 10, wherein the electrodes are attached to a connector plate via pre-load springs.

13. The device of claim 12, further comprising a ball-bearing housing configured to be attached to the motor device using the connector plates.

14. The device of claim 13, wherein the ball-bearing housing further configured to attach to a ball-joint.

15. The device of claim 14, wherein the USM-tip is configured to be attached to a bottom of the ball-joint.

16. The device of claim 15. wherein the ball-joint configured to attach the motor-tip to at least one of a robotic arm and an actuator.

17. A system, comprising:
a plurality of electrodes configured such that a bottom surface of each of the electrodes is attached to a bottom surface of another of the electrodes and a side surface of each of the electrodes is attached to a side surface of another of the electrodes; and
each of the electrodes having notch in vicinity of a notch of the other electrodes such that the notches form an opening at the center of the motor device,
wherein each of the electrodes is a PZT electrode configured to be excited by electric signal.

18. The system of claim 17, further comprising a motor-tip attached near top edges of the plurality of electrodes.

19. The system of claim 17, further comprising a plurality of connector plates, wherein the electrodes are attached to the connector plate via pre-load springs.

20. The system of claim 19, further comprising a ball-bearing housing configured to be attached to the motor device using the connector plates.
